(19) United States
(12) Patent Application Publication
(10) Pub. No.: US 2012/0271669 A1
(43) Pub. Date: Oct. 25, 2012

(54) METHOD AND SYSTEM FOR DETERMINING A SUSTAINABILITY METRIC

(76) Inventors: Bruce Stewart Taper, North Bondi (AU); George Douglas Magee Cole, Austinmer (AU); Robert Helstroom, Petersham (AU); David John Parry, Balmain (AU); David Brian Eckstein, Rozelle (AU); Wendy Ruth Bornholdt, Darlinghurst (AU)

(21) Appl. No.: 13/000,003

(22) PCT Filed: Apr. 3, 2009
(86) PCT No.: PCT/AU2009/000408

§ 371 Date: Aug. 19, 2011

(30) Foreign Application Priority Data
Jun. 18, 2008 (AU) 2008903103

(51) Int. Cl. G06Q 10/08

(52) U.S. Cl. 705/7.11

(57) ABSTRACT

An electronically implemented method of determining and managing a sustainability metric of one or more inventory groups is disclosed. Each group comprises one or more operational units. The method receives at least one of consumption data and one or more inventory parameters associated with each of the one or more inventory groups. A factual sustainability metric of the one or more inventory groups is determined, based on the received at least one of consumption data and one or more inventory parameters. A model sustainability metric of the one or more inventory groups in at least one model scenario, is also determined. The model scenario comprising modifying at least one of received consumption data and a received inventory parameter, to assess the effect of the modification on the factual sustainability metric.

### FIELD OF INVENTION

The present invention relates to processing inventory data and, in particular, to a method and a system for determining a sustainability metric, such as greenhouse gas emissions. The method and system may be used in monitoring, formal reporting, modelling and strategy evaluation of sustainability metrics. Thus the method and the associated system represent an essential tool for managing the sustainability metrics of a portfolio of assets.

### DESCRIPTION OF BACKGROUND ART

In recent years, the issue of sustainability has become increasingly important on a global level. Sustainability metrics include greenhouse gas emissions, water consumption, waste generation, embodied greenhouse gas emissions and embodied water. Of these, by far the most discussed sustainability metric has been greenhouse gas emissions (GHGE). Greenhouse gas emissions arise from a wide range of sources during any commercial or industrial activity. Greenhouse gas emissions include direct emissions from combustion of fossil fuels on-site for heating or cooking or in motor vehicles and other transport means. The sources of greenhouse gas emissions may also include indirect emissions from combustion of fossil fuels to supply electrical energy for commercial or industrial activity. The direct or indirect emission of greenhouse gases to the atmosphere from generation of waste and the release of certain substances, such as refrigerants and solvents, may also be included.

In order to be used for inter-agency carbon reporting and trading, quantification of such emissions as tonnes equivalent of CO₂ must be carried out in accordance with internationally recognised protocols, such as the International Standards Organisation (ISO) 14064:2006. These protocols prescribe regular reporting and place emphasis on the performance of greenhouse mitigating actions. The actions are often defined in terms of effected change with respect to a user-specified base year or any other benchmark data.

Because of an imperative for action on reducing global emissions, accounting for and formal reporting of greenhouse emissions is rapidly becoming an acknowledged responsibility for all large businesses. Carbon accounting computer programs that facilitate formal reporting already exist. However, these programs are limited to reporting and do not offer any flexibility in terms of managing sustainability metrics.

### SUMMARY OF THE INVENTION

It is an object of the present invention to substantially overcome, or at least ameliorate, one or more disadvantages of existing arrangements.

According to one aspect of the invention, there is provided an electronically implemented method of determining a sustainability metric of one or more inventory groups. Each group comprises one or more operational units. The method comprises the step of receiving at least one of consumption data and one or more inventory parameters associated with each of the one or more inventory groups. The method also comprises the step of determining a factual sustainability metric of the one or more inventory groups, based on the received at least one of consumption data and one or more inventory parameters. The method also comprises the step of determining a model sustainability metric of the one or more inventory groups in at least one model scenario. The model scenario comprises modifying at least one of the received consumption data and a received inventory parameter, to assess the effect of the modification on the factual sustainability metric.

According to a second aspect of the invention, there is provided apparatus for determining a sustainability metric of one or more inventory groups, each group comprising one or more operational units, the apparatus comprising;
an input for receiving at least one of consumption data and one or more inventory parameters associated with each of the one or more inventory groups;
memory for storing data received from the input and data obtained by processing the input data; and
processor, being in communication with the input and the memory, the processor being arranged for;
   determining a factual sustainability metric of the one or more inventory groups, based on the received at least one of consumption data and one or more inventory parameters; and
   determining a model sustainability metric of the one or more inventory groups in at least one model scenario, the model scenario comprising modifying at least one of received consumption data and a received inventory parameter, to assess the effect of the modification on the factual sustainability metric; and
an output for transmitting data related to at least one of the determined factual sustainability metric or the determined model sustainability metric to a user.

According to a third aspect of the invention, there is provided a computer readable medium, having a program recorded thereon, where the program is configured to make a computer execute a procedure for determining a sustainability metric of one or more inventory groups, each group comprising one or more operational units, the program comprising;
executable code for receiving at least one of consumption data and one or more inventory parameters associated with each of the one or more inventory groups;
executable code for determining a factual sustainability metric of the one or more inventory groups, based on the received at least one of consumption data and one or more inventory parameters;
executable code for determining a model sustainability metric of the one or more inventory groups in at least one model scenario, the model scenario comprising modifying at least one of received consumption data and a received inventory parameter, to assess the effect of the modification on the factual sustainability metric.

According to a fourth aspect of the invention, there is provided a system for determining a sustainability metric of one or more inventory groups, each group comprising one or more operational units, the system comprising;
communication means for receiving at least one of consumption data and one or more inventory parameters associated with each of the one or more inventory groups, and for transmitting data related to a determined sustainability metric to a user;
storage means for storing data received from the communication means and data obtained by processing the received data; and
processing means being in communication with the communication means and the storage means, the processing means being arranged for;
   accessing received data stored in the storage means;
   determining a factual sustainability metric of the one or more inventory groups, based on the received at least one of consumption data and one or more inventory parameters; and
   determining a model sustainability metric of the one or more inventory groups in at least one model scenario, the model scenario comprising modifying at least one of received consumption data and a received inventory parameter, to assess the effect of the modification on the factual sustainability metric; and
   transmitting data related to at least one of the determined factual sustainability metric and the determined model sustainability metric to a user, via the communication means.

Further aspects, such as a computer product comprising the computer medium of the third aspect, are also provided.

### BRIEF DESCRIPTION OF THE DRAWINGS

FIG. 1 is a flow diagram showing a method of determining a sustainability metric;

FIG. 2 is a schematic diagram of user interactions with a computer program implementing the method of FIG. 1;

FIG. 3 is a schematic diagram showing calculation and database transaction flows associated with the implementation of the method of FIG. 1;

FIG. 4 shows an example of modelling and strategy evaluation associated with the method of FIG. 1;

FIG. 5 is intentionally blank;

FIG. 6 is a sample report of the amount of gas consumed by individual assets within a portfolio of assets for a particular year, as well as the associated greenhouse gas emissions (GHGE);

FIG. 7 is a sample report of the greenhouse gas emissions (GHGE) of a portfolio of assets in a given year (2006-2007);

FIG. 8 is a sample report of the GHGE of a portfolio of assets in a given year (2006-2007), compared to that of a base year (2005-2006);

FIG. 9 is a sample entry page for entering data associated with the consumption of electricity by a particular inventory group and for a defined period of time;

FIG. 10 is a reporting summary of the GHGE of a portfolio of assets for a given year (2006);

FIG. 11 shows a sample report of asset allocation of GHGE of a portfolio of assets in a given year (2006-2007), compared to that of a base year; and

FIGS. 12A and 12B form a schematic block diagram of a general purpose computer system upon which the method of FIG. 1 may be practised.

### DETAILED DESCRIPTION

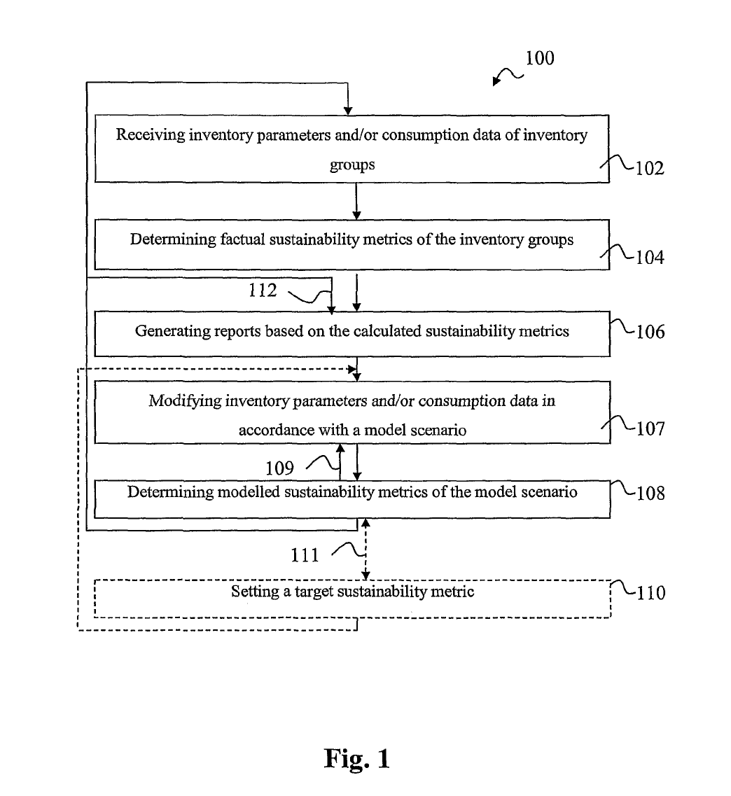

A method 100 of determining a sustainability metric is described below with reference to FIG. 1. The method 100 may be used for managing greenhouse gas emissions (GHGE). In particular, the management of GHGE includes reporting, modelling and monitoring of the GHGE. However, the method 100 may also be applicable to managing other sustainability metrics arising from various commercial activities. Such other sustainability metrics include water consumption, waste generation, embodied energy and embodied water.

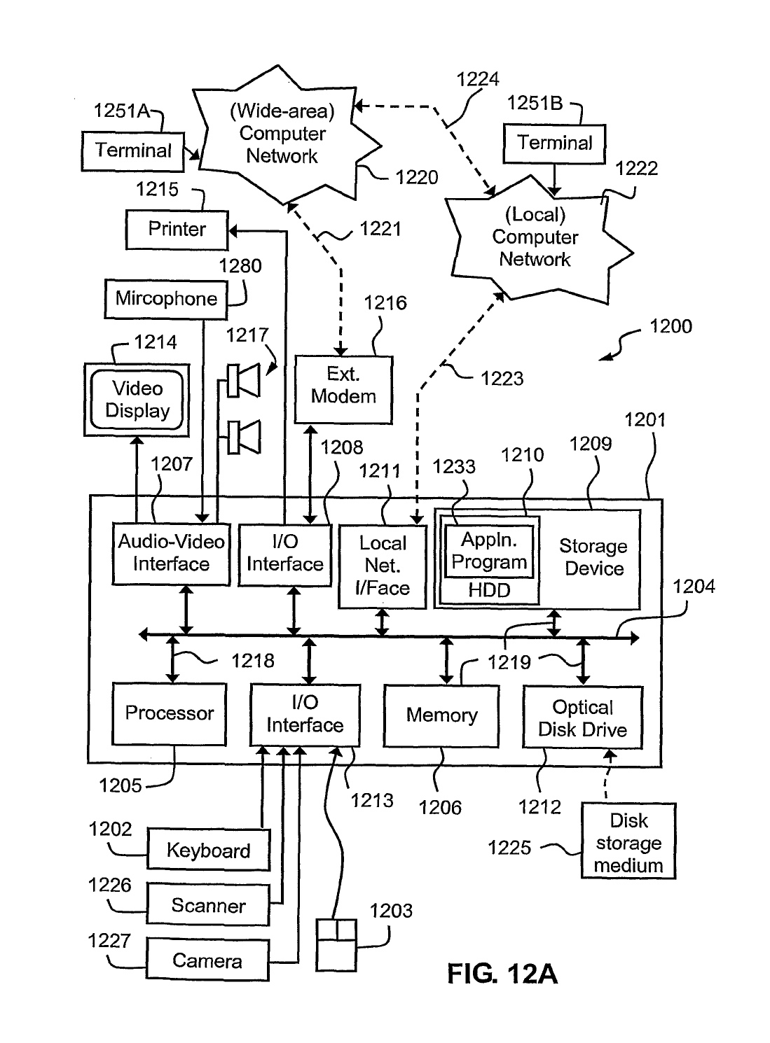

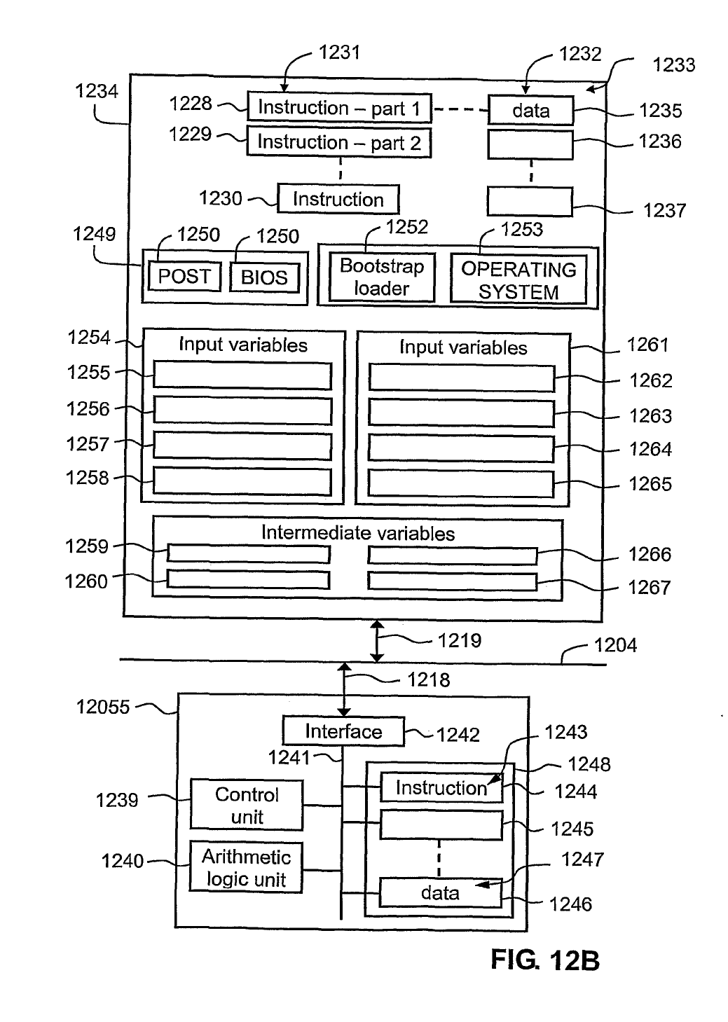

FIGS. 12A and 12B collectively form a schematic block diagram of a general purpose computer system 1200, upon which the method 100 may be practised.

As seen in FIG. 12A, the computer system 1200 is formed by a computer module 1201, input devices such as a keyboard 1202, a mouse pointer device 1203, a scanner 1226, a camera 1227, and a microphone 1280, and output devices including a printer 1215, a display device 1214 and loudspeakers 1217. An external Modulator-Demodulator (Modem) transceiver device 1216 may be used by the computer module 1201 for communicating to and from a communications network 1220 via a connection 1221. The network 1220 may be a wide-area network (WAN), such as the Internet or a private

WAN. Where the connection 1221 is a telephone line, the modem 1216 may be a traditional “dial-up” modem. Alternatively, where the connection 1221 is a high capacity (eg: cable) connection, the modem 1216 may be a broadband modem. A wireless modem may also be used for wireless connection to the network 1220.

The computer module 1201 typically includes at least one processor unit 1205, and a memory unit 1206 for example formed from semiconductor random access memory (RAM) and semiconductor read only memory (ROM). The module 1201 also includes a number of input/output (I/O) interfaces including an audio-video interface 1207 that couples to the video display 1214, loudspeakers 1217 and microphone 1280, an I/O interface 1213 for the keyboard 1202, mouse 1203, scanner 1226, camera 1227 and optionally a joystick (not illustrated), and an interface 1208 for the external modem 1216 and printer 1215. In some implementations, the modem 1216 may be incorporated within the computer module 1201, for example within the interface 1208. The computer module 1201 also has a local network interface 1211 which, via a connection 1223, permits coupling of the computer system 1200 to a local computer network 1222, known as a Local Area Network (LAN). As also illustrated, the local network 1222 may also couple to the wide network 1220 via a connection 1224, which would typically include a so-called “firewall” device or device of similar functionality. The interface 1211 may be formed by an Ethernet™ circuit card, a Bluetooth™ wireless arrangement or an IEEE 802.11 wireless arrangement. A terminal 1251A is located on the WAN 1220 and is, thus, connected to the computer module 1201 via a connection 1221. Similarly, a terminal 1251B is located on the LAN 1222 and is connected with module 1201 by way of a link 1223.

The interfaces 1208 and 1213 may afford either or both of serial and parallel connectivity, the former typically being implemented according to the Universal Serial Bus (USB) standards and having corresponding USB connectors (not illustrated). Storage devices 1209 are provided and typically include a hard disk drive (HDD) 1210. Other storage devices such as a floppy disk drive and a magnetic tape drive (not illustrated) may also be used. An optical disk drive 1212 is typically provided to act as a non-volatile source of data. Portable memory devices, such optical disks (eg: CD-ROM, DVD), USB-RAM, and floppy disks for example may then be used as appropriate sources of data to the system 1200.

The components 1205 to 1213 of the computer module 1201 typically communicate via an interconnected bus 1204 and in a manner which results in a conventional mode of operation of the computer system 1200 known to those in the relevant art. Examples of computers on which the described arrangements can be practised include IBM-PC's and compatibles, Sun Sparcstations, Apple Mac™ or alike computer systems evolved therefrom.

The method 100 for determining a sustainability metric may be implemented using the computer system 1200 wherein the processes of FIGS. 1 to 4, to be described, may be implemented as one or more software application programs 1233 executable within the computer system 1200. In particular, the steps of the method 100 are effected by instructions 1231 in the software 1233 that are carried out within the computer system 1200. The software instructions 1231 may be formed as one or more code modules, each for performing one or more particular tasks. The software may also be divided into two separate parts, in which a first part and the corresponding code modules performs various steps of the method 100 and a second part and the corresponding code modules manage a user interface between the first part and the user.

The software 1233 is generally loaded into the computer system 1200 from a computer readable medium, and is then typically stored in the HDD 1210, as illustrated in FIG. 12A, or the memory 1206, after which the software 1233 can be executed by the computer system 1200. In some instances, the application programs 1233 may be supplied encoded on one or more CD-ROM 1225 and read via the corresponding drive 1212 prior to storage in the memory 1210 or 1206. Alternatively the software 1233 may be read by the computer system 1200 from the networks 1220 or 1222 or loaded into the computer system 1200 from other computer readable media. Computer readable storage media refers to any storage medium that participates in providing instructions and/or data to the computer system 1200 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external of the computer module 1201. Examples of computer readable transmission media that may also participate in the provision of software, application programs, instructions and/or data to the computer module 1201 include radio or infra-red transmission channels as well as a network connection to another computer or networked device, and the Internet or Intranets including e-mail transmissions and information recorded on Websites and the like.

The second part of the application programs 1233 and the corresponding code modules mentioned above may be executed to implement one or more graphical user interfaces (GUIs) to be rendered or otherwise represented upon the display 1214. Through manipulation of typically the keyboard 1202 and the mouse 1203, a user of the computer system 1200 and the computer application program 1233 may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1217 and user voice commands input via the microphone 1280.

FIG. 12B is a detailed schematic block diagram of the processor 1205 and a “memory” 1234. The memory 1234 represents a logical aggregation of all the memory devices (including the HDD 1210 and semiconductor memory 1206) that can be accessed by the computer module 1201 in FIG. 12A.

When the computer module 1201 is initially powered up, a power-on self-test (POST) program 1250 executes. The POST program 1250 is typically stored in a ROM 1249 of the semiconductor memory 1206. A program permanently stored in a hardware device such as the ROM 1249 is sometimes referred to as firmware. The POST program 1250 examines hardware within the computer module 1201 to ensure proper functioning, and typically checks the processor 1205, the memory (1209, 1206), and a basic input-output systems software (BIOS) module 1251, also typically stored in the ROM 1249, for correct operation. Once the POST program 1250 has run successfully, the BIOS 1251 activates the hard disk drive 1210. Activation of the hard disk drive 1210 causes a bootstrap loader program 1252 that is resident on the hard disk drive 1210 to execute via the processor 1205. This loads an operating system 1253 into the RAM memory 1206 upon which the operating system 1253 commences operation. The operating system 1253 is a system level application, executable by the processor 1205, to fulfil various high level functions, including processor management, memory management, device management, storage management, software application interface, and generic user interface.

The operating system 1253 manages the memory (1209, 1206) in order to ensure that each process or application running on the computer module 1201 has sufficient memory in which to execute without colliding with memory allocated to another process.

Furthermore, the different types of memory available in the system 1200 must be used properly so that each process can run effectively. Accordingly, the aggregated memory 1234 is not intended to illustrate how particular segments of memory are allocated (unless otherwise stated), but rather to provide a general view of the memory accessible by the computer system 1200 and how such is used.

The processor 1205 includes a number of functional modules including a control unit 1239, an arithmetic logic unit (ALU) 1240, and a local or internal memory 1248, sometimes called a cache memory. The cache memory 1248 typically includes a number of storage registers 1244-1246 in a register section. One or more internal buses 1241 functionally interconnect these functional modules. The processor 1205 typically also has one or more interfaces 1242 for communicating with external devices via the system bus 1204, using a connection 1218.

The application program 1233 includes a sequence of instructions 1231 that may include conditional branch and loop instructions. The program 1233 may also include data 1232 which is used in execution of the program 1233. The instructions 1231 and the data 1232 are stored in memory locations 1228-1230 and 1235-1237 respectively. Depending upon the relative size of the instructions 1231 and the memory locations 1228-1230, a particular instruction may be stored in a single memory location as depicted by the instruction shown in the memory location 1230. Alternately, an instruction may be segmented into a number of parts each of which is stored in a separate memory location, as depicted by the instruction segments shown in the memory locations 1228-1229.

In general, the processor 1205 is given a set of instructions which are executed therein. The processor 1205 then waits for a subsequent input, to which it reacts to by executing another set of instructions. Each input may be provided from one or more of a number of sources, including data generated by one or more of the input devices 1202, 1203, data received from an external source across one of the networks 1220, 1222, data retrieved from one of the storage devices 1206, 1209 or data retrieved from a storage medium 1225 inserted into the corresponding reader 1212. The execution of a set of the instructions may in some cases result in output of data. Execution may also involve storing data or variables to the memory 1234.

The disclosed arrangements use input variables 1254 that are stored in the memory 1234 in corresponding memory locations 1255-1258. The processing of the input data in accordance with the method 100 produces output variables 1261, that are stored in the memory 1234 in corresponding memory locations 1262-1265. Intermediate variables may be stored in memory locations 1259, 1260, 1266 and 1267.

The register section 1244-1246, the arithmetic logic unit (ALU) 1240, and the control unit 1239 of the processor 1205 work together to perform sequences of micro-operations needed to perform “fetch, decode, and execute” cycles for every instruction in the instruction set making up the program 1233. Each fetch, decode, and execute cycle comprises:
(a) a fetch operation, which fetches or reads an instruction 1231 from a memory location 1228;
(b) a decode operation in which the control unit 1239 determines which instruction has been fetched; and
(c) an execute operation in which the control unit 1239 and/or the ALU 1240 execute the instruction.

Thereafter, a further fetch, decode, and execute cycle for the next instruction may be executed. Similarly, a store cycle may be performed by which the control unit 1239 stores or writes a value to a memory location 1232.

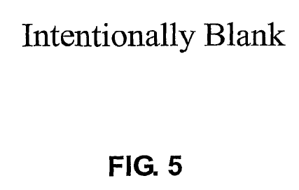

Each step or sub-process in the processes of FIGS. 1 to 11 is associated with one or more segments of the program 1233, and is performed by the register section 1244-1247, the ALU 1240, and the control unit 1239 in the processor 1205 working together to perform the fetch, decode, and execute cycles for every instruction in the instruction set for the noted segments of the program 1233.

Thus, the calculating and modelling routines that implement the method 100 are executed and controlled by the processor 1205. Input data associated with the described method 100 may be stored in an electronic file of a file-system configured within the memory 1206 or hard disk drive 1210 of the computer module 1201, for example. Similarly, reporting factual data and modelling data may also be stored in the hard disk drive 1210 or memory 1206.

However, the reporting factual data and/or the modelled data may also be generated on-the-fly by a software application program resident on the hard disk drive 1210. The reporting factual data and/or the modelled data may be displayed on the display 1214 or printed on printer 1215.

The method 100 may alternatively be implemented in dedicated hardware such as one or more integrated circuits performing the functions or sub functions shown if FIGS. 1 to 11. Such dedicated hardware may include graphic processors, digital signal processors, or one or more microprocessors and associated memories.

Modelling capabilities described below are an important improvement when compared to previous carbon accounting applications and include setting of targets and developing mitigation and reduction verification strategies. In particular, the described method 100 allows modelling of a possible portfolio of assets scenarios, described by different inventory parameters, and the calculating of GHGE resulting from the operation of a given portfolio of assets. Such a portfolio is usually subdivided into subgroups of assets consuming the same or similar types of energy resources. The assets may include buildings, building sites, shopping centres, factories etc. A group or subgroup of assets will be referred to as an “inventory group”.

The inventory parameters may include number, type and technical data of various assets included in an inventory group associated with a business sustainability account. The inventory parameters may also include resource bases (e.g., fuel, energy, refrigeration gas use etc.), number and type of operational units within an inventory group, as well as any efficiency coefficients of the operational units.

Generally, a commercial activity associated with GHGE may be concerned with ownership and operation of buildings, with the provision of goods and services and/or the manufacture, processing or supply of goods and/or materials. Flexibility to describe the activities of any enterprise is provided in accordance with the described method 100 by means of data structures and modular components that can be combined to reflect a great variety of business structures.

The method 100 allows a greenhouse emissions account to be assembled for a given portfolio of physical assets according to internationally recognised protocols. Account data allows an overview to be extracted of the consumption of a broad range of resources. The method 100 also allows the quantification of various strategies for mitigating resultant greenhouse emissions, through changes to inventory parameters. The inventory parameters are directly or indirectly related to the business activities, the number and/or the type of assets associated with a particular portfolio.

As will be described below, the method 100 is implemented by the one or more application programs (e.g., 1233) that are hosted on a dedicated application server. As the computer module 1201 represents a typical implementation of such a server, the computer module 1201 will also be referred to below as an “application server 1201”. In one implementation, the application server 1201 will be maintained by a company that provides service administration of the method 100 and the application program 1233. This company may be referred to as the service administrator. Apart from the service administrator, there are users, which represent other companies that wish to use the services including the method 100 as facilitated by the service administrator. Any account data associated with the structure of a business organisation (referred to below as a portfolio of assets) may also be stored on the application server 1201. Alternatively, the account data may be stored on a user company's server with a secure connection to the application server 1201. Implementations where the user company provides its own service administration and all the data is stored on the application server 1201 may also be envisaged.

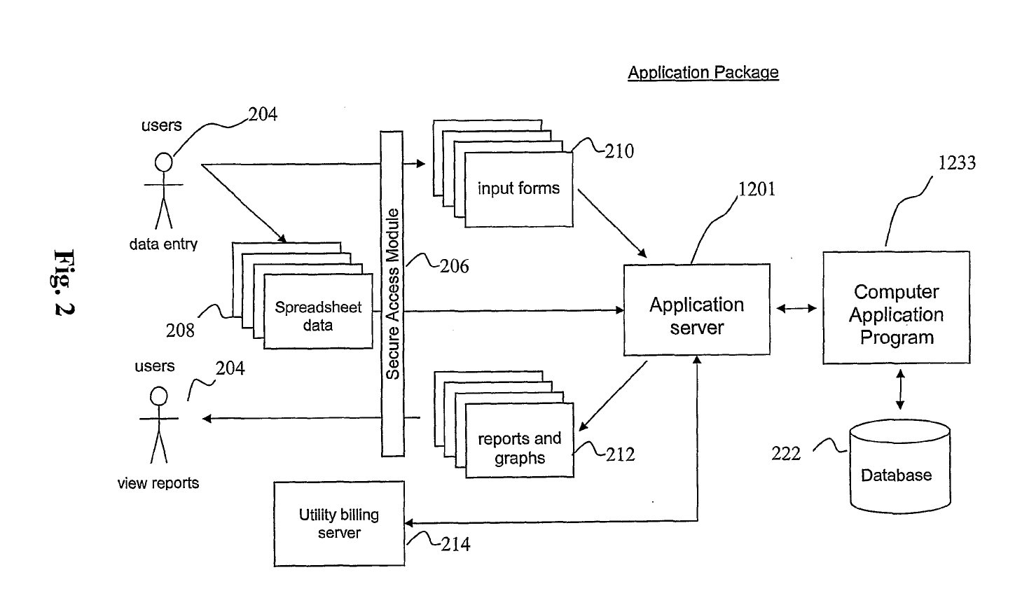

Similarly, any consumption data that is entered into the system 1200 may also be stored, in an information database 222 (see FIG. 2) or otherwise, configured within the hard disk drive 1210 of the application server 1201. Alternatively, the information database 222 may be stored on a separate user company's server. In this case, the data may be uploaded via a secure connection to the application server 1201. The system 1200 may be arranged for such uploads on a regular basis or only for uploads on demand. Typically managers or dedicated officers located at the various assets in a portfolio will have the responsibility of entering the consumption data. The consumption data entry may be effected by way of local or remote terminals 1251A and 1251B, communicating with the application server 1201 by way of the WAN 1220 and LAN 1222, respectively.

The consumption data may comprise one or more operational parameters associated with the use of the operational units within an inventory group (i.e., a group of assets). The value of each operational parameter is in some way indicative of the resource consumption of the respective inventory group. For example, the operational parameters may be related to the number of operational units in each asset or inventory group (i.e., group of assets), the recourse consumption of one operational unit or a group of units etc.

The consumption data is processed and used to model various scenarios taking into account the nature of a greenhouse source, the location of that source, the implementation of a particular strategy for a particular activity or a specific time period. In one implementation, the method 100 allows a base year to be specified as a reference point for greenhouse emissions. Any modelling of acquisition and divestment of assets may then be automatically adjusted to compare any predicted GHGE (or sustainability metrics) with that of the base year. Pro-forma reports may be readily prepared for submission to various regulatory authorities, and the effectiveness of any specific greenhouse gas modelling or mitigation activity may be evaluated for the purpose of recalibration of the assumed inventory parameters.

In order for the method 100 to provide assessment, reporting, strategy evaluation and mitigation functionalities, a broad set of resource consumption data is entered into the information database 222. On the basis of this consumption data, GHGE (or sustainability metrics) of a given portfolio of assets are determined according to one or more greenhouse gas accounting protocols. As described above, any entry of consumption data and any reports generated by the method 100 may either be stored locally on the application server 1201 storage media, including the application database 222, or on external memory device 1225. Alternatively, the consumption data may be transmitted electronically by the processor 1205, via local network 1222 or WAN 1220, to a user company's server (not shown).

The consumption data may be presented according to a variety of standards and predetermined user-defined reporting formats. This facilitates establishment of fully quantified greenhouse gas reduction targets. The modelling processes performed in accordance with the method 100 provide a clear direction as to how such targets can be reached and the cost of implementing any reduction strategy. The obtained real-time data may then serve as an indicator of progress towards the targets. This allows the value of certain strategies to be reassessed according to the monitored outcome.

A suite of possible emission reduction strategies may be provided for in the computer application program 1233 implementing the method 100. These strategies include actions such as installation, modification or de-commissioning of various building services or equipment. Such services may include, for example, lighting systems, air conditioning or ventilation equipment, hot water boilers, lifts, co-generation plants. Other strategies may extend to the uptake of more fuel efficient vehicles, installation of renewable energy systems, waste minimisation, for example. All strategies are able to be described by simple menu selection and data entry by the user, using the computer application program 1233, and are scientifically modelled to determine their effect on energy consumption. Various scenarios may be analysed and the modelled sustainability metrics determined for each scenario then compared. The calculations underlying the particular modelled scenario may also take into account geographic location and automatically adopt temperature (i.e. temperature patterns over time) and other climate data appropriate to the locale of a particular business activity. The computer application program 1233 permits an almost unlimited number of scenarios to be invoked, explored and then stored (e.g., in the information database 222) for appraisal and implementation.

The method 100 determines sustainability metrics such as greenhouse gas emissions based on factual resource usage or modelled resource usage, according to a comprehensive set of emission factors. The emission factors describe the direct and indirect GHGE implications of the use of each particular resource and are applied in accordance with relevant international greenhouse gas accounting standards, such as ISO 14064:2006. The emission factors may correspond to the respective sustainability metric, to the nature of the respective resource consumed by one or more inventory groups, or to both the sustainability metrics and the consumed resources. The emission factors are constantly updated to remain in accordance with the appropriate accounting standards and may take into account the geographic location of the commercial activity.

With respect to access and user rights, the computer application program 1233 is arranged to provide various personnel within a respective business activity, enterprise or organisation with prescribed levels of access to the information database 222 and the computer application program 1233. Such prescribed levels of access are both intended to safeguard data and to provide an automatically and fully documented audit trail.

The method 100 may be electronically implemented by way of the computer application program 1233 being executed on the dedicated application server 1201. The sustainability metric determined in accordance with the method 100 may be used for managing GHGE of a particular portfolio of assets. The main steps of the method 100 are shown in FIG. 1. Further details of the method 100, as well as the associated electronic system and computer program 1233 that implement the method 100, are described with reference to FIGS. 2 to 11.

In order to facilitate the application of the method 100, the consumption data related to a portfolio of assets can be subdivided into one or more inventory groups. Each inventory group may comprise one or more operational units of specific type and is associated with one or more inventory parameters. For example, one inventory group may be formed of industrial machines, lighting and other appliances that consume grid energy. Another inventory group may comprise one or more transport vehicles consuming petrol, diesel or gas fuel. A third inventory group may comprise one or more cooling and/or heating appliances using Chlorofluorocarbon gasses.

The inventory groups may also have different structures and may include, for example, building sites, buildings, shopping centres; at least some of which may include operational units consuming different energy resources, such as grid energy or petrol.

The method 100 starts with the step 102 where the computer application program 1233, under the execution of the processor 1205, receives consumption data indicative of a resource consumption of the one or more inventory groups under consideration. The received consumption data may be purely related to the consumption of one or more resources. Alternatively, the consumption data may be indicative of the business structure of a company, in terms of number of inventory groups, as well as the resource consumption of operational units or inventory groups. For example, the consumption data may comprise the number of appliances and the energy consumption of each appliance within an inventory group. Alternatively, the consumption data may include a single amount representative of the total consumption of all appliances within the inventory group.

The consumption data may be only indirectly related to the amount of a consumed resource. For example, instead of providing directly the amount of energy consumed by an individual unit, data may be received that includes hours of operation and hourly energy consumption of the unit. This data is still indicative of, and may be used for the determination of the energy consumption of the unit.

If the operational units are vehicles, the consumption data may include not the litres of consumed petrol, but the number and type of vehicles and the kilometres travelled by each vehicle. An efficiency coefficient, which in this case may be related to the consumption of each particular type of vehicle per one kilometre (or per hundred kilometres) is either provided by the user or included in the information database 222. Once this data is entered, the overall litres of respective fuel (e.g., petrol, diesel or gas) that the entire inventory group has consumed may be determined.

If an inventory group consists of vehicles, another way of managing and processing the consumption data may include subdividing the inventory group into two or more subgroups. Apart from the number of subgroups and the number of kilometres travelled by each subgroup, the input consumption data may in this case also include an efficiency coefficient for each subgroup. The efficiency coefficient in this case may indicate how the resource consumption of a particular subgroup compares with the resource consumption of another inventory group (of known resource consumption) or with benchmark resource consumption. For example, if a hybrid vehicle has an efficiency coefficient of 1.0, a conventional petrol car of the same size may have a coefficient of 0.7, while a larger vehicle may have an efficiency coefficient of 0.5 or less, depending on the mass of the vehicle and size of its associated engine. The received consumption data then allows the relative total consumption of each subgroup to be determined with respect to given benchmark data. If necessary, absolute consumption may also be obtained on the basis of the known consumption of the benchmark subgroup.

Alternatively, the data entered into the information database 222, configured within the hard disk drive 1210, may actually include the type of resources and the amount of consumed resource of each type. In this instance, the data received at step 102 of the application program 1233, when executed by processor 1205, may include the consumption of grid energy (e.g., by all types of appliances), various fuels (e.g., consumed either directly by a particular fleet, or indirectly, by hiring taxis or by purchasing of bus, train and airline tickets), as well as CFC, HFC and HCFC and other gases (e.g., associated with leakages of refrigerators and air conditioners). The number and/or type of appliances, vehicles or other operational units included in each subgroup (or inventory group) may also be included if detailed modelling is to be performed on the basis of the received data.

The process of entering the consumption data is typically effected by authorised management staff at the user's sites via the input terminals 1251A and 1251B, linked to the dedicated application server 1201 by way of WAN 1220 or LAN 1222, respectively. After undergoing security checks, a user may access the application server 1201 for entering consumption data, business data and/or extracting a report of performed scenario modelling in accordance with the method 100.

Once the consumption of all inventory groups is entered and/or received by the computer application program 1233 executed by processor 1205, at the next step 104, factual (or real life) GHGE (i.e., sustainability metrics), of the inventory groups are determined. The GHGE sustainability metric determined in such a manner is also referred to as a “factual sustainability GHGE metric” or “factual sustainability metric”. The determination of the factual sustainability GHGE metric is effected by numerical calculations embodied in the computer application program 1233. The calculations are based on the received consumption data, on the one or more inventory parameters associated with each of the one or more inventory groups and on one or more predetermined emission factors. The emission factors effectively transfer each quantity of a respective resource into a corresponding amount of GHGE. These emission factors are obtained from established, but regularly reviewed and possibly revised national and/or international protocols and standards. Once the factual sustainability GHGE metric is determined by the computer application program 1233, executed by the processor 1205 of the application server 1201, the factual sustainability GHGE metric is stored in the computer memory 1206 and/or the information database 222. Upon a user's request, the computer application program 1233, under the execution of the processor 1205, may generate a specific report including the determined factual sustainability GHGE metric. Alternatively, one or more reports may be generated automatically. The reports are generated in step 106 of FIG. 1. The reports are based either on a portion of, or on the entire data included in determining the determined factual sustainability metric. The format of these reports conforms to the respective reporting requirements of the business as well as various national and/or international protocols and standards. The various reports generated by the computer application program 1233 implementing the method 100 will be described in more detail below.

Because of the availability of fast internet and network connections, the method 100 may effectively provide real-time reporting on various sustainability metrics as well as flexible means of tracking progress towards meeting predetermined sustainability metric (e.g., GHGE) targets.

Modelling routines are implemented by the computer application program 1233 implementing the method 100 in steps 107 and 108 of FIG. 1. The modelling routines are associated with varying one or more inventory parameters. The modelling routines are triggered either automatically or upon user request. By way of such modelling, the processor 2105, at step 108, executes the computer application program 1233 to determine a model sustainability metric of one or more inventory groups in at least one model scenario. The at least one model scenario includes modifying one or more inventory parameters associated with the respective one or more inventory groups included in the modelling (i.e., step 107). The model sustainability metric related to the particular model scenario may then be determined in step 108. The determination of the model sustainability metric is effected again by the application program 1233 operating on application server 1201 under the execution of the processor 1205. The determined model sustainability metric may be stored by processor 1205 in memory 1206 and/or the information database 222 and is used to facilitate an assessment of the affect of the at least one model scenario on the respective one or more sustainability metrics.

Either some or all of the consumption data, the one or more predetermined emission factors and the one or more modified inventory parameters are used in the modelling. Only a portion of the data sets of consumption data, predetermined emission factors and modified inventory parameters are used when, for example, modelling of only some of the inventory groups is required. In addition, the purpose of the modelling is to investigate the effect of a particular change on the GHGE. Accordingly, while most of the parameters used in the modelling are identical with those used to obtain the factual sustainability metric, some of the inventory parameters or the consumption data will usually be varied for determining the factual sustainability metric. Thus, only some of the factual consumption data will be used during the modelling.

In the method 100, the computer application program 1233 is executed by the processor 1205 of the application server 1201 to determine, on the basis of the received consumption data and on the basis of one or more predetermined emission factors, various scenario outcomes. Each scenario includes different modification of the associated inventory parameters, and therefore, leads to different determined model sustainability metrics for one or more of the inventory groups. The resultant model sustainability metrics may be stored in memory 1206 and/or in the information database 222. Alternatively, for safe storage, the processor 1205 may transmit the model sustainability metrics data, by way of the LAN 1222 or WAN 1220 to a remote server. This separate server may be based at the premises either of the service administration company that manages the computer application program 1233 implementing the method 100, or that of a user company that owns the managed portfolio of assets.

Using the method 100, the overall GHGE (i.e., sustainability metric) may be managed so as to minimise the overall GHGE or keep the overall GHGE in line with a benchmark GHGE. This benchmark GHGE may be the emission achieved in a given base year or a target emission defined by other means.

The model parameters may be reassessed if any factual sustainability metrics have been derived as a result of an implementation of a previously modelled scenario. In this case, any factual data relating to the implementation of the model scenario is firstly compared with the theoretical predictions of the model. The comparison is then used to recalibrate or otherwise adjust any modelling parameters or routines such that their prediction is in closer conformity with the factual data. In this way, the predictive accuracy of the employed modelling routines and parameters is continuously reviewed and improved.

The modelling performed at step 107 of the method 100 typically comprises introducing changes to one or more inventory parameters of the portfolio of assets or a single asset (e.g., one inventory group). Once a change of one or more inventory parameters is introduced, the model is used to determine the resulting model GHGE sustainability metric. The determined model GHGE sustainability metric is then compared with benchmark data. Such benchmark data may include determined reporting factual data that reflects the real GHGE of the portfolio of assets, a base year GHGE reporting factual data, yearly average GHGE factual data determined over a predetermined number of years and determined model data modelling another proposed strategy.

For example, one strategy may include changing the inventory parameters of the model by reducing the overall number of vehicles in a company's fleet or the number of vehicles of a particular type. The available data for the number, the consumption and the emission factors of a proposed number and type of vehicles may then be used to determine a predicted GHGE for a desired reduced number of vehicles. The resulting GHGE savings may also be determined. Similarly, a predicted consumption may be determined that arises from the implementation of an alternative strategy of maintaining, or even increasing, the number of vehicles, but changing the type of at least some of the vehicles to a more fuel efficient type. The results from these different strategies may then be compared to each other and/or with GHGE data of a base year. A change in the type of vehicles used may necessitate a change in the emission factors used in the modelling. This may be caused by either the vehicles using different type of energy resource or having a different GHGE efficiency.

One or more selected model scenarios may be implemented to generate one or more desired factual sustainability metric outcomes. Further iterations, represented by arrow 109, may be effected by changing one or more inventory parameters, calculating the resulting GHGE and comparing with the results obtained for other scenarios. Reports similar to those generated in relation to the factual sustainability metric, may also be generated in relation to any model sustainability metric, as indicated by arrow 112. In accordance with the example immediately above, the results of the modelling performed at step 107 may be used as a basis for making business decisions relating to the future of the company's vehicle fleet. Factual sustainability metric outcomes may be generated from the changed inventory parameters by implementing selected strategies.

Instead of, or in addition to, modifying one or more inventory parameters, the consumption data may also be varied in order to obtain a resultant model sustainability metric outcome. For example, instead of being reduced, the number of vehicles can be kept the same, but different types of more economical vehicles can be introduced. This will reduce the consumption parameters and the overall sustainability parameter footprint of the respective inventory group. Again, a series of iterative steps may be performed until a desired outcome for the model sustainability metric is achieved.

In some implementations of the method 100, the parameter modification step 107 and the metric determining step 108 will only be triggered in response to a specific target sustainability metric being set in step 110. In this case, the computer application program 1233 may include a database (e.g., the information database 222) with predetermined sets of modifications for the inventory parameters and/or the consumption data. Each such set or series of sets will correspond to a range of differences between the calculated factual sustainability metric and the target sustainability metric. The choice of modified parameters may be provided or entered in step 107. This will be again followed by step 108 that will assess the resultant model sustainability metric for the particular parameter change. A comparison of the resultant model sustainability metric and the target sustainability metric (indicated by arrow 111) may trigger further iteration steps. Different modifications are tried until a model sustainability metric is generated that is within a predetermined range of the target sustainability metric. Since the step of setting a target sustainability metric is optional, it is outlined in FIG. 1 with dotted line.

FIG. 2 represents in more detail some of the user interactions employed by the method 100 in determining the model sustainability metric and delivering the described data transaction, calculation, reporting and modelling strategies. The processor 1205 of the application server 1201 executes the computer application program 1233 that implements the method 100. The computer application program 1233 may be run by a user 204 either locally, from the application server 1201 itself, or remotely—from the remote terminals 1251A and 1251B.

When executing the computer application program 1233, the processor 1205 may access the information database 222 configured within the hard disk drive 1210 of the application server 1201. Alternatively, the information database 222 may be located on another server (not shown), which may be connected to the LAN 1222 or WAN 1220, such that the information database 222 can be securely accessed by the application server 1201.

The information database 222 comprises data relevant to any calculations that the computer application program 1233 may need to perform in relation to energy resources and sustainability metrics. Such data may include, for example, the values of the data emission factors for the particular resources, the values of the efficiency coefficients of various appliances, vehicles, machines, heaters, coolers, lighting devices. The information database 222 may also include reporting formats or other parameters required for the implementation of the method 100 and its compliance with relevant national or international standards.

The application server 1201 is accessible, simultaneously or otherwise, by a number of authorised users 204. A secure-access code module 206 may be provided to avail particular administrative rights and functionality to specified users only. The secure access code module 206 may be implemented on the application server 1201 or the terminals 1251A and 1251B to provide rules and permissions related to the operation of method 100. Such rules and permissions may, for example, provide different users with different levels of access to the computer application program 1233 and the information database 222. As an example, senior management of an organisation may have the exclusive rights to set greenhouse gas mitigation targets, while managers of particular assets (or facilities) owned and/or managed by the organisation may only be able to enter resource usage data and monitor the performance of a particular asset against the prescribed targets. All changes to the information database 222 are recorded by the computer application program 1233 against each user, so as to provide a clear audit trail and a means by which the status of an asset, facility or a consumption account may be rolled back in time.

Any inventory parameters and/or consumption data provided by the user to the database 222, according to step 102 of method 100, is also submitted by way of the secure-access code module 206. Various means for both automatic and user-initiated entry of real-time resource usage data are provided. Examples include automatically up-loadable spreadsheet data 208 and entry forms 210 arranged for manual upload. The upload may be effected by way of the link 1223 or 1221, while the data entry can be performed on the terminals 1251A and 1251B.

All determined, or otherwise inferred, information is as up to date as the most recent resource consumption data received by the processor 1205 (as at step 102). Once new inventory and/or consumption data is received, the processor 1205 may execute the computer application program 1233 to effect steps 104, 107 and 108 and determine the factual sustainability metric and various model sustainability metrics of the respective inventory groups for which data has been provided. The computer application program 1233 may then generate or update any report (and graphs) 212, generated as per step 106 of method 100. Such substantially instantaneous report generation and update can provide real-time summaries of the greenhouse gas emission (or sustainability metric) performance of all activities of the particular business activity (or commercial operation). Such real-time summaries may include the formal reporting protocols, the effect of reduction strategies, target quantification, base year references and all graphical representations.

In one implementation, the computer application program 1233 implementing the method 100 may track in real time the performance of an implemented model scenario by receiving electricity billing data or vehicle fuel billing data from a respective utility billing server 214. Server 214 may be connected to the application server 1201 by way of the LAN 122 or WAN 120. Any connection to server 214 may again be effected via secure-access code module 206.

The generated reports may be presented to an administrator managing the application server 1201. Any such reports may be displayed on the display 1214 or printed by printer 1215. Alternatively, the reports may be faxed, emailed or otherwise communicated to a secure server owned by the user. The reported data may include any data from determined factual or model sustainability metrics, as well as any model scenarios including respective modification changes to inventory parameters and/or consumption data. Apart from being forwarded to the respective user, the reporting data can also be saved in electronic memory 1206 or other storage media associated with the computer application program 1233, which may be located either on server 1201 or on another remote computer system. The stored reporting data may also include any data that is produced by the computer application program 1233 but is not forwarded to the user in the form of a report.

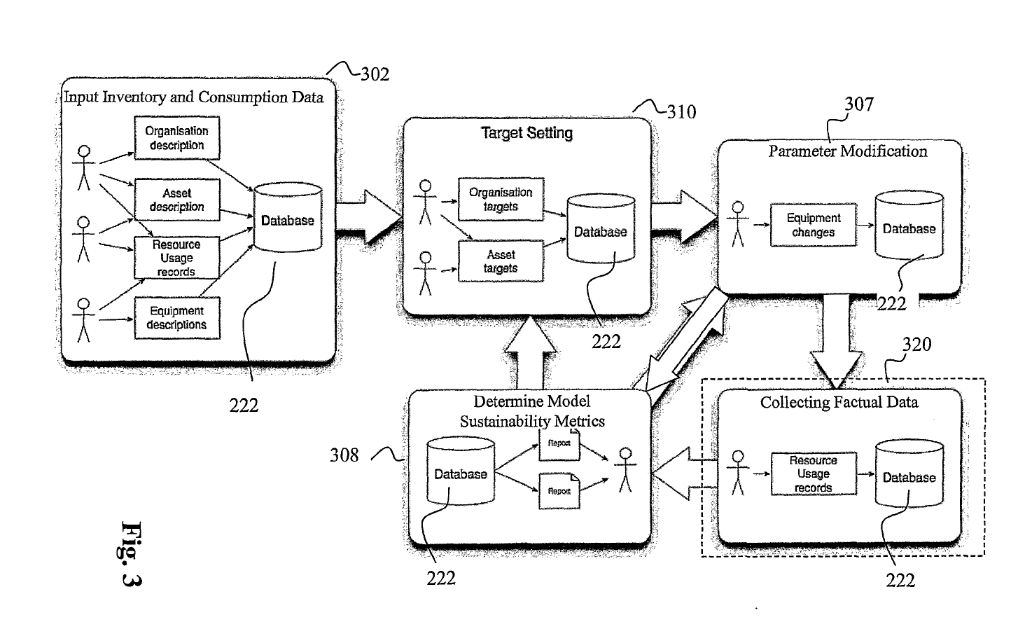

The information transaction flows of the calculation and information database 222, which facilitate the numerical modelling and generate the model sustainability metric output provided by the method 100, are shown in FIG. 3.

As seen in FIG. 3, module 302 represents the transaction flows associated with step 102 of the method 100, in which the processor 1205 runs the computer application program to receive input data including inventory parameters and consumption data. This is effected by data being provided, possibly by more than one source, as to the organisational, asset, resource usage and equipment description of the managed portfolio of assets (or asset portfolio). Such input data establishes a full description of the commercial activity (or operation), including all relevant inventory parameters and consumption data.

Interdependence is preferably established between the inventory groups in terms of a flexible “has many” and a “belongs to” classification scheme to describe the physical and business relationships underlying the commercial activities of the business in question. Current and historical resource usage data, entered by the user or automatically uploaded from utility portals, completes an establishment phase of the description and provides the means for calculation and compilation of the current and historical GHGE or other sustainability metrics. The input data can be stored on the information database 222, which is based on the application server 1201. However, the input data may also be stored on a remote secure server located at the user's premises.

As seen in FIG. 3, module 310 represents interactions associated with step 110 of setting one or more target sustainability metrics. The target sustainability metrics may be related to separate inventory groups (or assets) or the entire asset portfolio. A benchmark value of greenhouse gas emissions for a given base year may serve as a reference point for a target setting process in the module 310. A set target sustainability metric may be provided by the user and stored by the processor 1205 in the information database 222.

Module 307 of FIG. 3 is associated with step 107 of modifying inventory parameters and/or consumption data in accordance with a particular model scenario. In the module 307, the processor 1205 may configure various scenarios, based on established targets and proposed changes. The various model scenarios are based on modifications proposed either by the user or by the processor 1205. The modifications associated with the proposed particular model scenario are also stored by the processor 1205 on the server 222.

Module 308 of FIG. 3 represents step 108, in which the processor 1205 evaluates the proposed modifications to any inventory parameters or consumption data. As a result of calculations performed 108, the model sustainability metric corresponding to the respective parameter modifications is determined. It has to be noted that the proposed modifications to any inventory parameters or consumption data, if implemented, will correspond to actual changes to assets, resource bases and equipment. The financial costs and benefits associated with the model sustainability metric outcome may also be determined by the processor 1205. The calculated model sustainability metric may be extracted from database 222, formatted into particular reporting formats and presented to the user as at step 106 of the method 100. The readily available model sustainability metric data corresponding to particular modification of inventory parameters or consumption data allows the assets, resource bases and equipment to be better managed.

At the initial stages of implementation of the method 100, the configuration of the various scenarios in the module 307 may be directly followed by the evaluation routines of module 308. This modelling, performed by processor 1205, provides immediate feedback on the effect of the proposed changes. The calculated model sustainability metrics may be compared to the target metric described above, to the results of alternative strategies or to otherwise defined benchmark metrics. Such benchmark metrics may, for example, represent determined factual yearly sustainability metric data or the sustainability metric achieved by a competitor. Only changes and strategies that lead to desired predicted effects and the modelling of which has indicated superior results are chosen for implementation and stored in memory 1206 or other electronic storage media for later retrieval.

Depending on the result of the comparison, further changes may be introduced to one or more inventory parameters. The modelling may then be re-run and the modelled yearly data for this new scenario may be compared with the previous data. Such a process of iterative adjustment of the modelled scenarios allows the identification of implementation changes that would minimise the resultant yearly sustainability metric. Alternatively, the intention may be to make the yearly sustainability metric equal or smaller than the determined factual yearly sustainability metric data, the other model sustainability metric or benchmark metric data.

Once a modelled strategy is implemented, the day to day factual (real) data associated with the GHGE resulting from the implementation of the chosen changes can be recorded in the information database 222 as shown in module 320. Such an ongoing entry of resource usage data over time provides the means by which the method 100 may be used to assess the implemented effectiveness of any particular change. That effectiveness may be used in future estimates of similar changes, for obtaining greater precision in the predicted sustainability metric outcomes. This may be implemented by introducing correction coefficients to account for the discrepancy between predicted and factual data. Thus, the method 100 may provide a feedback loop that allows factual data of the effects of any implemented strategies to be used for assessing of the respective strategy and adjusting a model to take into account the results of this assessment.

Certain strategies are employed in the calculation processes that facilitate the transaction and data flows outlined in FIG. 3 to operate in a manner that minimises any computationally intensive workload, commonly encountered in such reporting calculations.

These include the caching of intermediate results by the computer application program 1233 as a means of pre-empting use and the implementation of a redetermination procedure, in the form of a recalculation, which recognises dependencies and thereby only re-evaluates a hierarchical subset of the full information database 222.

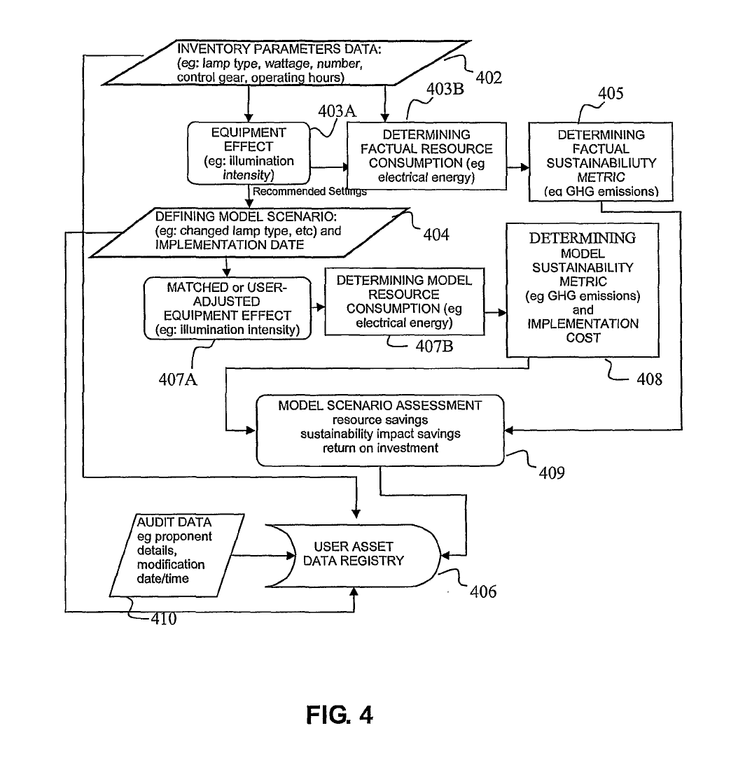

An example of evaluating strategies for reducing GHGE in a designated part of a building using the method 100, will now be described with reference to the block diagram of FIG. 4. The example shown in FIG. 4 is concerned with the lighting arrangements of a user's inventory group. The modelling process starts with block 402, in which the user provides inventory parameter data, as per step 102 of the method 100. The inventory parameters obtained in block 402 are associated with the existing lighting installation, including lamp types, number of lamps, wattage, control gear, operating hours etc.

The inventory data provides sufficient information for the processor 1205 and the computer application program 1233 to determine the equipment user related effect (such as illumination intensity) of the existing lighting installation and the factual resource consumption (i.e. electrical energy), as shown by block 403A and 403B, respectively. In block 405, the factual sustainability metric (i.e., GHGE) of the lighting inventory group is determined, as per step 104 of the method 100.

The next block 404 is representative of step 107 of method 100, in which a model scenario is determined including particular modification of the provided inventory parameters. Proposed mortifications may be made on the basis of introducing new processes and/or parameters, removing existing processes and/or inventory parameters or introducing changes to an existing process or inventory parameter.

The model scenario determined in block 404 may be either input by a user or may be automatically designated by the processor 1205, by accessing the information database 222, which may also include information regarding predetermined strategies. Alternatively, the new strategy may be determined, in an iterative manner, by determining various combinations of parameters in view of minimising the GHGE.

In the particular example shown in FIG. 4, one scenario may include replacing the current lamps with a smaller number of new and more efficient lamps. Such a change is expected to reduce the overall consumed grid power but preserve the end-use impact (that is, the total lighting intensity). An alternative scenario may, for example, include substituting a portion of the lamps with more powerful lamps, thus allowing a change in the end-user impact as well as the overall consumed grid power.

Once a model scenario is determined, the resultant effect of the proposed modifications is determined. In the case of FIG. 4, block 407A represents a model calculation of the end user-related performance. Similarly, the resource consumption of the model inventory data is calculated in block 407B. Finally, in block 408, the computer application program 1233, executed by the processor 1205, determines the model sustainability impact of the model scenario by determining the model GHGE sustainability metric associated with the model scenario. The process allows the user to adjust the equipment making up the lighting installation and determine the effect of the adjustments.

Block 409 represents the next stage of the modelling process according to the example of FIG. 4, in which a user or the processor 1205 and the computer application program 1233 implementing the method 100 assesses each model scenario. This may, for example, be done by comparing the model sustainability metric generated in block 408 with the factual sustainability metric obtained in block 405. This is equivalent to step 110 of the method 100, in which a determined model sustainability metric was compared against a predetermined target. The assessment of the model scenario may also take into account the associated changes in resource use, sustainability impact as well as monetary costs and benefits predicted by the model.

It would be appreciated that in its most general application, FIG. 4 describes the assessment of the effect of any particular action associated with the assets, processes and equipment included in a managed portfolio of assets (or asset portfolio). Particular action may include, for example, a change to the lighting, ventilation, heating, cooling, hot water supply, water pumping, building fabric, renewable energy systems or the cogeneration systems of buildings, as well as a change in the fuel efficiency of fleet vehicles, waste management practices, refrigerant consumption and handling, air travel, consumption of raw and processed materials.

The modelling results of blocks 407A, 407B and 408 are recorded by the computer application program 1233, along with the associated model scenario, in an asset data registry 406. The asset registry 406 may be part of the information database 222 or of a database located on a user's server.

Once the model sustainability metric has been determined, an implementation date may be prescribed to invoke the change. The date is also recorded together with the resource use and cost predictions for all activities that are dependent on a changed process or activity.

As discussed in relation to FIG. 3, the modelling predictions may, at a later date, be compared to the real outcome of the actual implemented changes, to generate a set of correction coefficients. This is represented by block 410 of FIG. 4. Generated numerical multipliers may be applied to future modelling of other similar activity or process changes, to derive improved estimates for the resource use, sustainability impacts and monetary costs resulting from the changes.

The computer application program 1233 employs relational datasets embodying structures, links and dependencies. These structures, links and dependencies describe, in a generalised way, the physical properties, as well as the connections and interactions of any organisational business structure and its physical assets. The interaction is in terms of operational units within each inventory group and interactions between inventory groups. Thus, the implementation of the method 100 employs a data model that has a direct correspondence with the physical system that is under analysis.

To better reflect the real links between any operational unit or inventory group and its surrounding environment, the relational datasets employed by the computer application program 1233 can take into account the influence of the local climate and temperature parameters. Such parameters may include data of the number of cool and hot days for a calendar year, as well as the quantity of direct solar and diffuse surface radiation. This information is directly relevant in terms of determining energy demand for heating, ventilation and air conditioning systems, as well as to establishing the operational regime of photovoltaic energy generation.

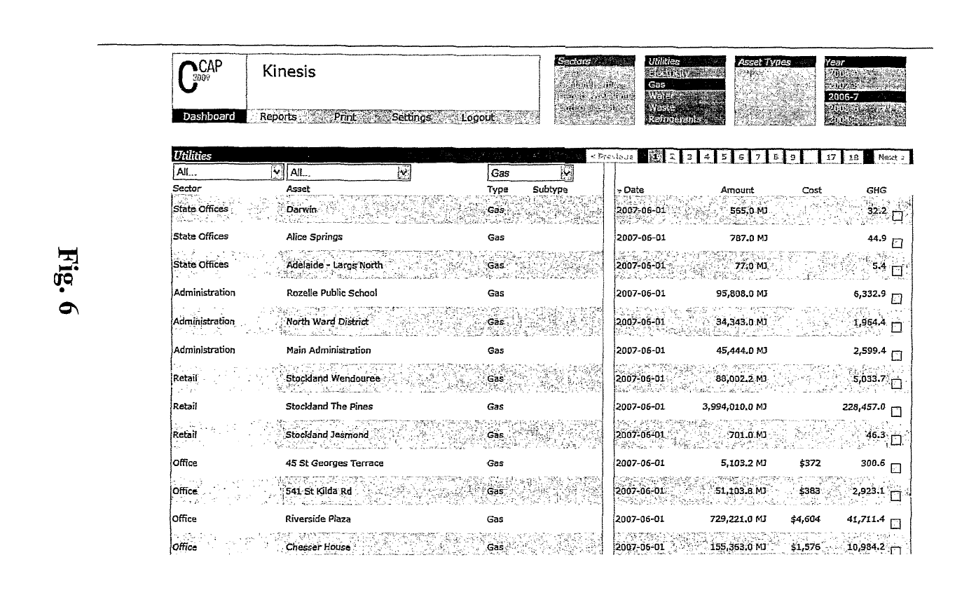

FIGS. 6 to 11 show various screen captures of images that might be electronically displayed to a user by the computer application program 1233, when executed by the processor 1205 to implement the method 100.

FIG. 6 is a sample report comprising the amount of particular resource (in this case a fuel gas) consumed by individual assets within particular business asset portfolio for a particular year. The administrative classification (i.e., office, administration, retail etc) and the location of each asset, as well as the associated cost of the consumed resource and the equivalent GHGE, are also shown in the report. The data included is for the calendar year accorded up to Jun. 1, 2007. The report of FIG. 6 may be generated as at step 106 of the method 100.

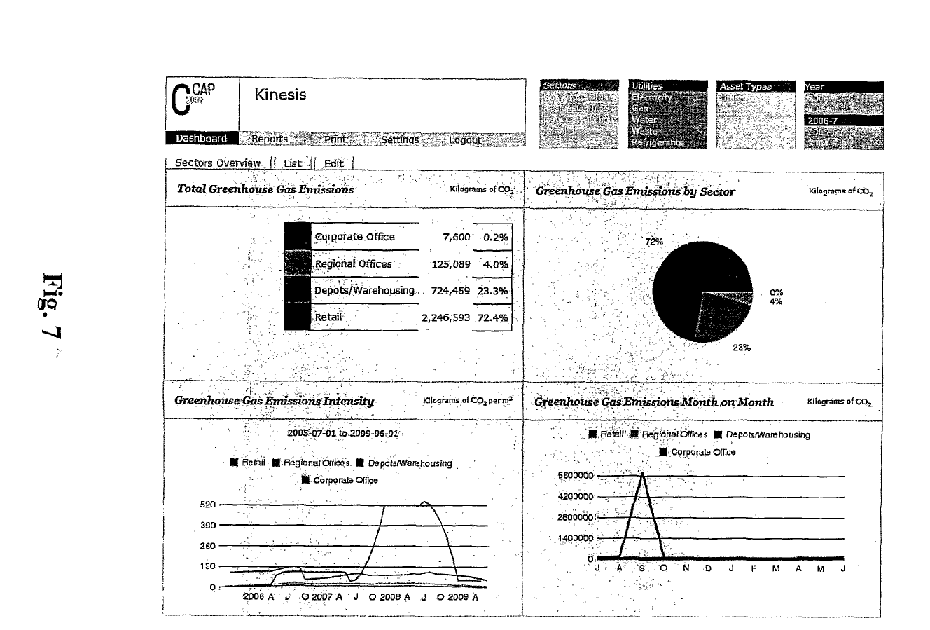

FIG. 7 is a sample report of the GHGE of a business in a given year (2006-2007), recorded for each business inventory group (division). The report of FIG. 7 may be generated at step 106 of the method 100. Again each inventory group is represented by the group's administrative classification (i.e., Corporate Office, Regional Office, Depots/Warehouses and Retail). The corresponding GHGE (in kilograms of CO₂) are recorded for each of the inventory groups. Apart from the specific amount of GHGE, the percentage ratio of the each respective GHGE of each inventory group to the total amount of GHGE of the entire business is also recorded. The respective contribution of the GHGE of each inventory group (in percentages), is visualised by way of a pie chart. In addition, the GHGE Intensity diagram (in kilograms of CO₂ per square metre of floor area) is shown in the report of FIG. 7 for each inventory group for the years 2006 to 2009. In addition, the report of FIG. 7 comprises a diagram of the month to month GHGE (in kilograms of CO₂) for each separate inventory group during the reporting year. Such diagrams allow the contribution of each inventory group to the GHGE and the GHGE Intensity to be compared on monthly and yearly basis.

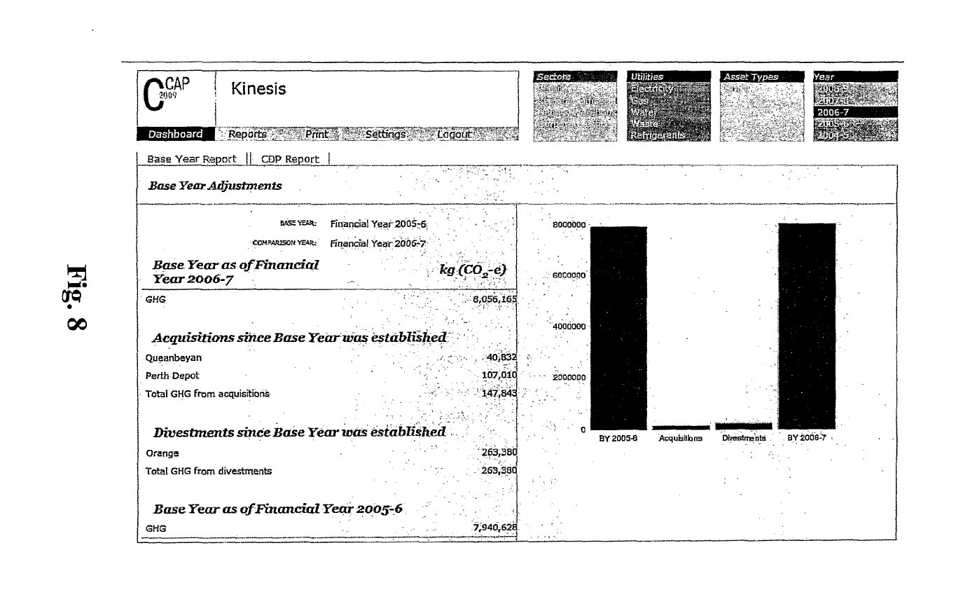

FIG. 8 is a sample report of the GHGE of an asset portfolio in a given year (2006-2007), compared to that of a base year (2005-2006). Again, the report of FIG. 8 may be generated as at step 106 of the method 100. The report of FIG. 8 comprises the amounts of GHGE (in kilograms of CO₂) for both a base and current financial year. The GHGE contributed by various events affecting the overall GHGE of the business is also shown. In particular, the events in consideration are two acquisitions of new businesses and one divestment. The GHGE for the year 2006-2007 is obtained by taking the GHGE for the base year 2005-2006, adding the GHGE contributed by the two newly acquired businesses and subtracting the GHGE of the divested business. A bar graph visualising the respective GHGE amounts for the base year, for each of the events and for the current year, is also included in the report of FIG. 8.

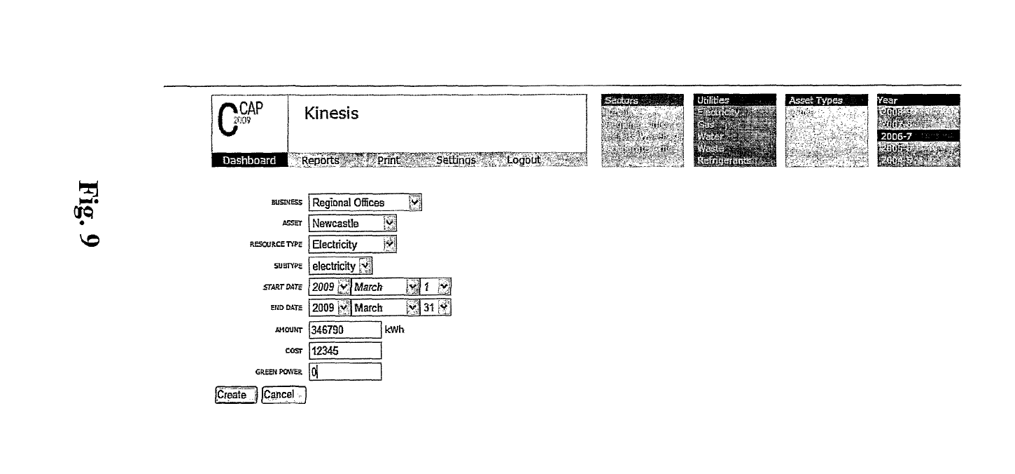

FIG. 9 is a sample entry page for entering data associated with the consumption of electricity by a particular inventory group and for a defined period of time. The page of FIG. 9 may be presented to a user for entering the consumption data as at step 102 of the method 100. In particular, the administrative classification of the inventory group (Regional Offices), the location of the inventory group (Newcastle), the type and subtype of resource consumed (in this case electricity) and the start and the end date of the relevant period, have to be entered by the user. In this particular example of FIG. 9, the total amount of energy (in kWh) and the total costs associated with this energy (in $) is also entered by the user.

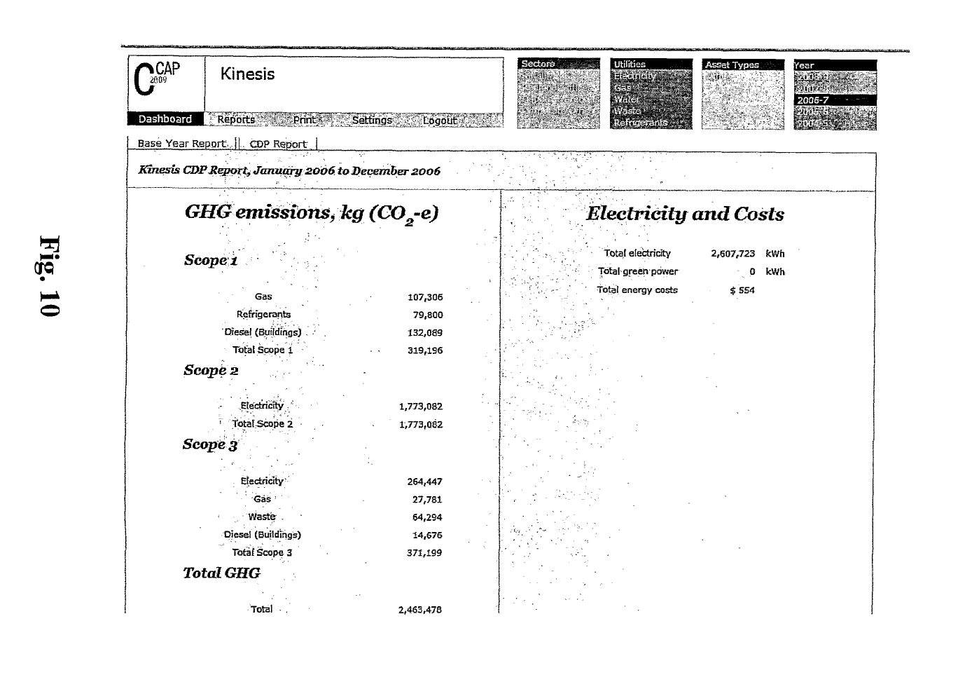

FIG. 10 is a reporting summary of the GHGE of a business for year 2006 (January 2006 to December 2006). Again the report of FIG. 10 may be generated as at step 106 of the method 100. The GHGE is subdivided into Scope 1, Scope 2 and Scope 3 emissions. The amount of emissions is measured in equivalent kilograms of carbon dioxide (CO₂-e). Scope 1 includes emissions of equivalent CO₂, in the form of the consumed gas, refrigerants and diesel (used for the heating of buildings). Similarly Scope 2 and Scope 3 GHGE are also specified. Scope 2 includes the use of electricity, while Scope 3 includes the indirect greenhouse emissions over which the business has no control, such as the leakage of gas from pipelines owned by other parties that supply its business with gas. The GHGE for each of Scope 1, Scope 2 and Scope 3 and the total GHGE for the entire business are also included in the report. Finally, a summary is also presented of the consumed electricity (in kWh) and the associated costs (in $) for the year.

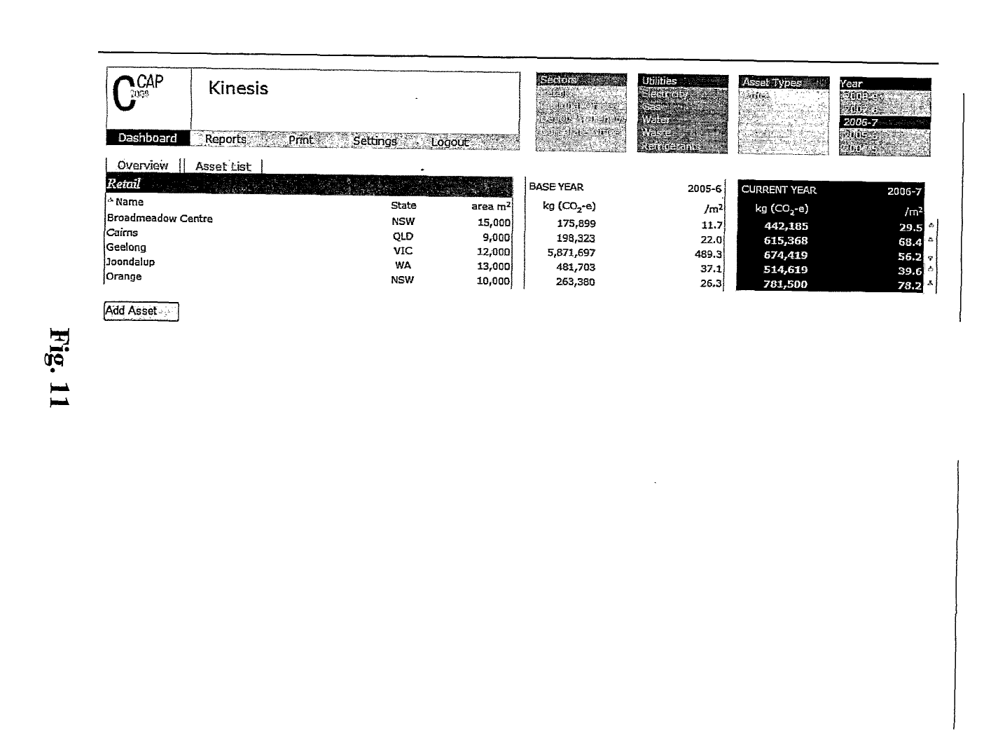

FIG. 11 shows a sample report of allocation of the GHGE (in kg CO₂-e) among assets (or operational units) within one inventory group (Retail) in a business asset portfolio for both a given year (2006-2007) and a base year (2006-2006). Again, the report of FIG. 11 may be generated at step 106. Each asset is recorded by way of the asset's location and area (in square meters). Apart from the GHGE, the report also includes the GHGE Intensity (in kg CO₂-e per square metre) for each inventory group for both the base year and the current accountable year.

The method 100 facilitates evaluation of various aspects of the GHGE associated with managing the commercial activities of a portfolio of assets. The foregoing text describes only some embodiments of the disclosed method. Modifications and/or changes can be made to the disclosed method without departing from its scope and spirit, the discussed embodiments being illustrative and not restrictive.

For example, whilst the above description was mainly directed to the method and the associated electronic system for reporting and modelling GHGE, the scope of the invention extends also to a computer program product having recorded thereon a computer program which is executable on the computer system 1200 to effect the described method 100.

Also, whilst the embodiment shown in FIG. 1 includes several modules, not all of them may be necessary in all implementations of the described method. For example, the step 106 of generating reports may not be included in some embodiments, which will be primarily directed to modelling various scenarios. In addition, step 107 may be integrated with step 108.

The computer system 1200 and the computer module 1201 were also described only as representative embodiments and other electronic arrangements and systems could be used to implement the described method.

In addition, whilst the above disclosure is mainly directed to the calculation and modelling of GHGE, other sustainability metrics, such as water consumption, waste generation, embodied energy and embodied water, for example, can be managed in a similar manner.

### Business Case Application Example

One implementation of the disclosed modelling method 100 will now be described by way of example with reference to a particular business application of the method 100.

In accordance with the example, Company A has access to the application server 1201 and the computer application program 1233. Company A has already provided consumption data to the application server 1201 in the form of an up to date ledger of all sources of its greenhouse gas emissions, as per step 102 of the method 100. The provided data in this particular example comprises periodical records of the electricity, gas and transport fuel consumption and related costs for all the assets of the company. The amount of each resource consumed can be used by the computer application program 1233, when executed by the processor 11205, to calculate the corresponding amount of associated GHGE. This is done by the consumed amount of given resource, i.e. grid energy, being multiplied with a respective emission coefficient specific for the respective resource.

The emission coefficients vary not only with different resources, but also within a single resource. The value of these emission coefficients are generally known for a particular resource or geographical area. For example, petrol has a carbon emission coefficient of 2.5 kg CO2/li. Further, the grid energy in one State (e.g. Victoria, Australia), where the production of grid energy is primarily based on a renewable sources, may have a lower emission coefficient, than the grid energy of another State (e.g. New South Wales, Australia), which relies primarily on burning coal for the production of its energy. A database of emission coefficients may be part of the database 222, or can be outsourced to a third party.

At the initial stages of execution of the method 100 for a particular company (e.g. Company A), the consumption data used (i.e. for determining the factual sustainability metric, as per step 104) may not be State or asset specific. Accordingly, an average emission coefficient value may be used for each energy resource in order to determine a corresponding amount of GHGE for an amount of the consumed resource in relation to Company A. Such an approach provides a broad, “bottom line”, summary of the resource consumption and greenhouse gas emissions (e.g., the sustainability metric) of a company (e.g., Company A).

The flexibility of the modelling provided by the computer application program 1233 allows the Company A to access a variety of factual data, calculated on the basis of the provided data. As per step 104, such data may include factual resource consumption and factual sustainability metrics.

For example, the provided consumption data may also be specified State by State (e.g., Victoria, Australia). Furthermore, the data for each State may be asset specific. Such data can provide a view of the business consumption and GHGE at an increasingly localised or otherwise detailed level, representing a fine-grained summary of the business GHGE. One example of a “fine grained” view would be a tabulation of total greenhouse gas emission by an inventory group represented by a building asset in a particular Australian State (for example, Victoria). This is achieved by taking the building specific data for the consumption of various energy resources and multiplying each specific amount by a respective emission coefficient. The emission coefficients used in this more detailed calculation are State-specific and allow much more accurate calculation of the factual GHGE metric.

Having access to the Computer application program 1233, Company A is able to propose possible greenhouse reduction targets, as per step 110 of method 100, and then investigate the feasibility and likely cost of meeting the targets. The modelling and GHGE optimisation process may start with identifying the major source (such as electricity consumption) of the company's greenhouse emissions. Since the computer application program 1233 has access to all the necessary inventory and consumption data, processor 1205 of server 1201 can immediately calculate and make available, upon request, any information related to energy consumption and the associated GHGE of either the entire Company A or any individual inventory groups.

In one arrangement, in order to identify the various sources and their contribution to the overall GHGE, the computer application program 1233 may automatically subdivide Company A's greenhouse emissions according to their underlying sources. This can be done for all levels of Company A's activities, from the sum total of the company's asset portfolio down to, for example, a warehouse building in particular State. It should be noted here that the initial focus of the target setting is often the sum total of the company's asset portfolio. The computer application program 1233 can effect the subdivision of the GHGE according to the GHGE sources. The minimum input data for this subdivision is the total consumption data for each energy resource, as well as the number and the type of assets in the asset portfolio. At this point of the modelling, the application program 1233 may not consider any asset specific data, but introduces the notion of “generic asset type”. For example, an office building can be one generic asset type and a factory can be another generic asset type. It is assumed that, for a generic asset type, electricity (for example) is consumed by lighting, HVAC, lifts, office machines, etc according to a generic breakdown for the particular type of asset (e.g. storage/warehouse building). Thus, each individual asset of a particular type is associated with a particular generic breakdown of equipment consuming specific energy resource. Such a generic breakdown allows reasonable estimates to be made of the contribution of the various systems within a building to the total consumption of each particular energy resource under review. Such generic breakdowns can also be included in the database 222.

Alternatively, the subdivision can be effected by receiving information from the user of the actual electricity breakdown of the business. Such breakdown includes the actual amount of each relevant energy resource, consumed by each asset. The breakdown can be provided by sub-meter records of actual consumption furnished to the inventory/consumption data set. Alternatively, the breakdown can be inferred by the computer application program 1233 from a description of the various electricity consuming installations comprising the asset, which are provided by the user.

Being based on energy consumption, the allocation of emissions can respond to all possible changes that might be implemented by Company A in end-use efficiency. For example, by using the computer application program 1233, Company A can investigate the model outcome of a model scenario including an improvement in lighting efficiency. In particular, the computer application program 1233 can model the effect of the proposed modification on the company's total electricity consumption and hence determine the effect on total greenhouse gas emissions based on model sustainability metrics, as per step 108 of the method 100.

As per step 106 of the method 100, algorithms employed by the computer application program 1233 can generate an end-use breakdown of, for example, electricity consumption at all levels of detail from the “broad-brush” overview of the entire company down to a fine-grained assessment of a single asset. The effect of an improved energy efficiency of newly introduced appliances or other greenhouse mitigation measures can be assessed in a way that its implications can be unambiguously quantified and resolved through all levels of application. Once the model GHGE metric is calculated, an estimate of the associated cost can be made of the model. That is, the method 100 implemented by the computer application program 1233 can assess the practicality of a fully-quantified greenhouse reduction target for Company A by recognising the implications (including estimated costs) of implementing the required efficiency measures and other changes down to an asset level, or even finer scale of application.

Once Company A has used computer application program 1233 to determine practical emission reduction targets (as per step 110 of the method 100) and identified the means by which Company A will realise these goals (as per step 107 of the method 100), the respective model scenario including particular inventory parameters of consumption data can be registered in the information database 222. Company A might, for example, register “Efficient T5 fluorescent lighting in all retail car parks” as one means under its emissions reduction strategy. The calculated emissions reduction, the user-related effect of the implementation measures (such as any change in the light intensity after implementation of the respective modification) and the proposed implementation date will also be recorded by the processor 1205 and the computer application program 1233 in the information database 222.

Once a respective scenario is implemented, factual energy consumption records provided to the computer application program 1233 will be used by the computer application program 1233 to determine the effectiveness of the implemented measure. In this particular example, the computer application program 1233 would report to Company

A all changes in the lighting energy in all its retail car parks and an assessment on whether the predicted energy and greenhouse savings had been realised. Along with the actual cost of implementing the measure, computer application program 1233 would annex empirical data from the implemented change and draw on this accumulating resource for future predictions of analogous changes elsewhere in company A's asset portfolio.

### Specific Example

The following discussion provide a numerical example of the operation of the computer application program 1233, executed by processor 1205, to facilitate setting of targets, devising modification strategies and evaluating the efficiency of the proposed greenhouse mitigation strategies.

As was mentioned in the overview above, the server 1201 and the computer application program 1233 have access to all inventory and consumption data associated with any inventory group of Company A, which is to be modelled.

Based on the available consumption data (i.e. in terms of tons of gas and petrol and MWh of energy consumed for the entire asset portfolio), the processor 1205 runs the computer application program 1233 to calculate, as per step 104 of the method 100, that Company A's greenhouse gas emissions (i.e., the factual sustainability metric) over the past year were 100,000 tonnes of CO₂-e. Company A had already committed itself to a 10% reduction in total greenhouse emissions in next year's account, as per step 110 of the method 100.

At this point company A may use the reporting feature of the computer application program 1233, as per step 106 of the method 100. In this initial stage of the execution of the method 100, the computer application program 1233 uses the inventory data of the number and the type of assets included in the asset portfolio of Company A. Based on the “generic asset type” concept, for each particular type of asset in the asset portfolio of

Company A, a model is defined of the asset portfolio of company A that can report the contribution of the various GHGE sources among the assets within the company. Such a report, especially when visualised with a suitable diagram, allows Company A to quickly identify that 85% of its GHG emissions were generated by the consumption of 80,000 MWh of electricity. Furthermore, it is automatically estimated that office lighting is responsible for 20,000 MWh of this annual electricity use. The automatic estimate may be made, for example, by reference to generic databases that allocate for each “generic” asset of a particular type, end-use emissions into fuel source and type, technology type and proportional representation within the assets emission profile, plus assumed efficiency factors. Moreover, in the present example with Company A, it is identified automatically that approximately ¾ of Company A's operations are based in a particular State (Victoria). This information may be important since it is known that in Victoria the greenhouse gas intensity of electricity is significantly greater than that of the electricity supplied to the company's assets in other States. The computer application program 1233 also indicates that the 15,000 MWh of lighting energy estimated to be consumed in Victoria is responsible for 20,000 tonnes of the company's annual GHG emissions.

One model scenario includes the installation of high efficiency lighting in all of the company's office assets in Victoria. As a “broad brush” starting point, Company A inputs to the computer application program 1233, representative average inventory parameters and consumption data of the company's lighting arrangements in Victoria. This description can be provided in a number of ways to the computer application program 1233. In the particular example, Company A decides to specify the currently installed lighting in terms of 1) its electrical power consumption per unit of lit floor area, 2) type of lamp and 3) type of lamp control gear.

As an example, the summary of the inventory and consumption data of Company A, provided to the computer application program 1233, indicates that the company's Victorian offices are fitted with 15 W/m² of T12 fluorescent lamps with standard magnetic ballasts. The processor 1205, by executing computer application program 1233, assesses that these lights operate with an overall luminous efficacy of 63 lumen/watt. Furthermore, Company A considers that, if these lamps are to be replaced, it would be desirable that any new lighting provides a 20% higher illumination level while consuming less energy for the same operational hours. At this point Company A considers a variety of lighting modification options presented by computer application program 1233 and model scenarios based on these options, as per step 107 of the method 100.

As a result, Company A finds that a fluorescent tube replacement employing 140 lumen/watt light emitting diodes (LEDs), integrated with high-efficiency electronic control gear, will provide the same illumination while consuming only 0.45 of the electrical energy. For an additional 20% illumination intensity, the modelling performed by the computer application program 1233 predicts that the retrofit will use 0.54 of the current electrical demand and will cost $6M, but will have a payback time of 5 years. This model scenario predicts an annual saving of 6,900 MWh of electricity and 9,200 tonnes of CO₂-e for the company. Accordingly, the model sustainability metric determined in accordance with the present example (as at step 108) is equal to 90,800 tonnes of CO₂-e (i.e., 100,000 tonnes−9,200 tonnes). This corresponds to a 9.2% reduction in the company's total GHG emissions. This calculation of the model sustainability metric substantially effects step 108 of method 100. The model scenario is recorded by processor 1205 into the information database 222 as “Broad-brush LED replacement office lighting, VIC”.

The above calculations were based on the assumption that each individual asset (i.e. office building), for example, has a particular number of lamps, as included in the definition of generic asset of this particular type. All lamps were assumed to be of the 15 W/m² T12 fluorescent lamps with standard magnetic ballasts, as mentioned above.

However, company A decides to conduct modelling of the proposed modifications at the level of individual assets, to obtain a more detailed image of the greenhouse savings and installation costs and remove any margin of error that may have been created by the generic assumptions made in the broad brush assessment. This more detailed image is now obtained on the basis of inventory sub-asset data associated with the number and type of appliances in each asset. This “finer grain” investigation is able to more accurately predict the outcome of the proposed lighting upgrade because it is able to take into account the fact that on inspection of certain office areas within certain assets, high-efficiency T5 lamps were already fitted some time ago and this information is then populated within the databases and is reconciled against fuel source, type and usage for that asset. This changes the forecast electricity saving to 6,375 MWh and the GHGE reduction to 8,500 tonnes (CO₂-e). This model scenario is also stored by processor 1205 into the information database 222 as “Asset-level LED replacement office lighting, VIC”. After the proposed model scenario has been approved by Company A's management, an implementation date is assigned and recorded in the information database 222.

Subsequently, company A runs the computer application program 1233 to explore more opportunities for meeting its GHGE reduction target by introducing suitable modifications to their fleet. Company A finds that a model scenario of converting 50% of the company's vehicle fleet to high fuel efficiency vehicles will yield a GHGE reduction of 2,000 tonnes of (CO₂)/yr. The computer application program 1233, run by processor 1205, calculates that this scenario, together with the lighting retrofit, will enable Company A to exceed its reduction target and achieve GHGE emissions savings of 10,500 tonnes of (CO₂)/yr. Accordingly, the new model sustainability metric determined in accordance with the present example (as at step 108) is equal to 89,500 tonnes of CO₂-e (i.e., 100,000 tonnes−10,500 tonnes). The model scenario associated with the above discussed modification is approved by the management and stored by processor 1205 in the information database 222 as “Vehicle fleet fuel efficiency”.

As the implementation dates of the above model scenarios pass, the computer application program 1233 may be constantly updated by factual data generated by the implementation of the modelled scenarios. In particular, the application program 1233 is able to track in real time the performance of the implemented scenarios from electricity and vehicle fuel billing data that is routinely entered into the database 222. The computer application program 1233 has also been provided with the actual costs of the retrofit and the vehicle changes. As the electricity and fuel consumption data grows, computer application program 1233 can gauge the effectiveness of the modification measures and hence build this into each model scenario with increasing accuracy. If, for example, the post-retrofit electricity billing data suggests that the LED replacement initiative is yielding an energy saving equivalent to 6,000 MWh/yr, then a correction factor of 0.94 will be included in subsequent calculations based on lighting retrofits analogous to the implemented scenario. Moreover, future versions of this scenario will also be informed with the actual retrofit cost rather than the notional cost that was first reported to the investigation. Likewise, the computer application program 1233 will draw upon the actual assessed performance and cost of the vehicle fleet changes to calibrate any future scenario predictions.

### INDUSTRIAL APPLICABILITY

The proposed method and system facilitate the development and evaluation of greenhouse reduction strategies, identification of targets and verification means by reviewing the success of such strategies. It also allows for data benchmarking Accordingly, the described method is relevant and can be implemented by any industry or organisation performing commercial and/or industrial activities and, therefore, having at least one quantifiable sustainability metric associated with those activities.

1. An electronically implemented method of determining a sustainability metric of a portfolio of assets, each asset including one or more groups, each inventory group including one or more operational units, the method comprising the steps of:
receiving at least one of consumption data and one or more inventory parameters associated with each of the one or more inventory groups;
determining a factual sustainability metric of the one or more inventory groups, based on the received at least one of consumption data and one or more inventory parameters; and
determining a model sustainability metric of the one or more inventory groups based on at least one model scenario, the model scenario including the step of modifying at least one of received consumption data and a received inventory parameter, wherein the model sustainability metric is utilisable to assess the effect of the modification on the factual sustainability metric.

2. The electronically implemented method of claim 1, wherein the factual sustainability metric is determined based on one or more predetermined emission factors corresponding to at least one of a respective sustainability metric or a respective resource consumed by the one or more inventory groups.

3. The electronically implemented method of claim 1, the model sustainability metric is determined on the basis of a portion of the received consumption data.

4. The electronically implemented method of claim 3, wherein the model sustainability metric is, determined on the basis of at least one predetermined emission factor.

5. The electronically implemented method of claim 1, wherein the method further comprising the step of generating a report based on data from at least one of a determined factual sustainability metric or the determined model sustainability metric.

6. The electronically implemented method of claim 1, wherein the method includes the further step of comparing the determined model sustainability metric of the one or more inventory groups in one model scenario with at. least one of:
the model sustainability metric of the one or more inventory groups determined for another model scenario;
the determined factual sustainability metric of the one or more inventory groups; or other benchmark sustainability metric data.

7. The electronically implemented method of claim 1, wherein the method being applied to a plurality of inventory groups, wherein at least one of the inventory groups consumes a different type of resource than the other inventory groups in the plurality of inventory groups.

8. The electronically implemented method of claim 5, wherein at least one of the step of determining a factual sustainability metric, the step of determining a model sustainability metric or the step of generating a report, is effected upon request by a user.

9. The electronically implemented method of claim 1 wherein, for at least one of the inventory groups, the received consumption data comprises a number of individual operational units and the respective resource consumption of each operational unit within the group.

10. The electronically implemented method of claim 1 wherein, for at least one of the inventory groups, the received consumption data comprises data of the total resource consumption of the operational units within the group.

11. The electronically implemented method of claim 1 wherein, for at least one of the inventory groups, the received consumption data comprises a value of an operational parameter associated with the use of the operational units within the group, the value of the operational parameter being indicative of the resource consumption of the respective group.

12. The electronically implemented method of claim 1, wherein at least one of the inventory groups comprising a plurality of subgroups, the associated consumption data for the inventory group comprising data of the number of subgroups, as well as an operational parameter and an efficiency coefficient associated with each subgroup, the efficiency coefficients indicating how the resource consumption of this subgroup compares with the resource consumption of at least one other group or with a benchmark resource consumption.

13. The electronically implemented method of claim 5, wherein the generated report is generated in one of a plurality of predetermined formats.

14. The electronically implemented method of claim 1, wherein a model scenario comprises:
introducing changes to at least one of the number of the operational units, a type of the operational unit and a resource base of the operational units in at least one of the inventory groups.

15. The method according to claim 14, further comprising the steps of:
determining the resulting model sustainability metric; and
comparing the determined model sustainability metric data with at least one of a previous year factual data, a base year modelled data, another scenario determined model data or other benchmark data.

16. The electronically implemented method of claim 14, wherein the method further comprises the steps of:
determining a factual yearly sustainability metric of one or more inventory groups;
introducing changes to one or more inventory parameters of at least one inventory group;
comparing the modelled yearly sustainability metric data with the determined factual yearly sustainability metric data or with other benchmark data; and
introducing other changes to one or more inventory parameters and making a further comparison, to identify implementation changes that would minimise yearly sustainability metric or make the yearly sustainability metric equal or smaller than the determined factual yearly sustainability metric data or the other modelled scenario metric or benchmark data.

17. The electronically implemented method of claim 16 wherein, after implementation changes have been identified and effected, factual inventory data is collected of the real effect of the changes on the sustainability metric of one or more inventory groups, the collected data is compared with the modelling data and respective one or more correction coefficients are introduced to the modelling process in order to account for the discrepancy between modelled and factual data.

18. The electronically implemented method of claim 1, wherein one inventory group comprises industrial operational units, lighting and other appliances consuming grid energy.

19. The electronically implemented method of claim 1, wherein one inventory group comprises one or more transport vehicles consuming petrol, diesel or gas.

20. The electronically implemented method of claim 1, wherein one inventory group comprises one or more cooling or heating appliances using refrigeration gasses.

21. The electronically implemented method of claim 1, wherein the step of determining the sustainability metric of a modelling scenario comprises processing data of at least one of; the climate, the geographic location and the temperature patterns at a location of at least one inventory group.

22. The electronically implemented method of claim 1, wherein the method further comprising the step of setting a target sustainability metric for the one or more inventory groups and introducing one or more model scenarios in order to achieve the target metric.

23. The electronically implemented method of claim 1, wherein at least one of the factual sustainability metric and at least one model sustainability metric is calculated by using a generic asset type.

24. The electronically implemented method of claim 1, wherein one of the sustainability metrics is greenhouse gas emissions.

25. Apparatus for determining a sustainability metric for a portfolio of assets, the assets including one or more inventory groups, each group comprising one or more operational units, the apparatus comprising:
an input means for receiving at least one of consumption data and one or more inventory parameters associated with each of the one or more inventory groups;
memory means for storing data received from the input and data obtained by processing the input data; and
processor means, being in communication with the input and the memory, the processor being arranged for;
determining a factual sustainability metric of the one or more inventory groups, based on the received at least one of consumption data and one or more inventory parameters; and
determining a model sustainability metric of the one or more inventory groups in at least one model scenario, the model scenario including modifying at least one of received consumption data and a received inventory parameter, wherein the model sustainability metric is utilisable to assess the effect of the modification on the factual sustainability metric; and
an output means for transmitting data related to at least one of the determined factual sustainability metric or the determined model sustainability metric to a user.

26. A computer readable medium, having a program recorded thereon, where the program is configured to make a computer execute a procedure for determining a sustainability metric of one or more inventory groups, each group comprising one or more operational units, the program comprising:
code for receiving at least one of consumption data and one or more inventory parameters associated with each of the one or more inventory groups;
code for determining a factual sustainability metric of the one or more inventory groups, based on the received at least one of consumption data or one or more inventory parameters;
code for determining a model sustainability metric of the one or more inventory groups in at least one model scenario, the model scenario comprising modifying at least one of received consumption data or a received inventory parameter, to assess the effect of the modification on the factual sustainability metric.

27. The computer readable medium of claim 26, wherein determination routines implemented by any of the executable code include at least one of:
caching of intermediate results as a means of pre-empting use; and
employing a redetermination procedure that recognises dependencies and thereby only re-evaluates a hierarchical subset of the full database.

28. A computer program product having a computer readable medium of claim 26 recorded therein.

29. A system for determining a sustainability metric of one or more inventory groups, each group comprising one or more operational units, the system comprising:
communication means for receiving at least one of consumption data and one or more inventory parameters associated with each of the one or more inventory groups and for transmitting data related to a determined sustainability metric to a user;
storage means for storing data received from the communication means and data obtained by processing the received data; and
processing means being in communication with the communication means and the storage means, the processing means being arranged for;
accessing received data stored in the storage means;
determining a model sustainability metric of the one or more inventory groups in at least one model scenario, the model scenario comprising modifying at least one of received consumption data and a received inventory parameter, to assess the effect of the modification of the factual sustainability metric; and
transmitting data related to at least one of the determined factual sustainability metric or the determined model sustainability metric to a user, via the communication means.
